(19) United States
(12) Patent Application Publication
(10) Pub. No.: US 2007/0020168 A1
(43) Pub. Date: Jan. 25, 2007

(54) Synthesis of long and well-aligned carbon nanotubes

(75) Inventors: Jes Asmussen, East Lansing, MI (US); Martin Hawley, East Lansing, MI (US); Shuangjie Zhou, Austin, TX (US); Stanley Shengxi Zuo, East Lansing, MI (US)

Correspondence Address: Ian C. McLeod;McLeod & Moyne, P.C., 2190 Commons Parkway, Okemos, MI, 48864, US

(73) Assignee: Board of Trustees of Michigan State University, East Lansing, MI (US)

(21) Appl. No.: 11/433,537

(22) Filed: May 12, 2006

Related U.S. Application Data
(60) Provisional application No. 60/680,561, filed on May 13, 2005.

(51) Int. Cl. D01F 9/12; H05H 1/24

(52) U.S. Cl. 423/447.3; 427/569

(57) ABSTRACT

A process for growth of a lawn of aligned carbon nanotubes is described. The nanotubes are useful for cold cathode flat panel display, composites reinforcement and damping treatment.

### CROSS-REFERENCE TO RELATED APPLICATIONS

This application claims benefit of Provisional Application No. 60/680,561, filed May 13, 2005.

### STATEMENT REGARDING FEDERALLY SPONSORED RESEARCH OR DEVELOPMENT

Not Applicable

### STATEMENT REGARDING GOVERNMENT RIGHTS

Not Applicable

### BACKGROUND OF THE INVENTION

(1) Field of the Invention

The present invention relates to a process for growth of a lawn of aligned carbon nanotubes. In particular, the present invention relates to a process which enables the provision of the catalyst on a substrate which supports the growth of the lawn of nanotubes in a single microwave plasma chemical vapor deposition chamber.

(2) Description of the Related Art

Carbon nanotubes have many potential applications in nanotechnology, because of their superior stiffness, strength, toughness, thermal conductivity, and unique electrical properties. Currently, methods for nanotubes synthesis include arc discharge, laser ablation, and chemical vapor deposition (CVD). The arc discharge method produces high quality single wall nanotubes (SWNT) with few structural defects and does not require a catalyst for synthesis of multiwall nanotubes (MWNT). However, the purity of nanotubes with the arc discharge method is usually very low. The laser ablation method produces nanotubes with high quality and high purity, but the process is very costly. The CVD method is used for rapid synthesis of nanotubes with high purity at lower temperatures and is easy to scale up for commercial production. The nanotube alignment is easy to control with this method, but the nanotubes synthesized with CVD usually have more structural defects compared with the other two methods.

Aligned carbon nanotubes are of particular interest for many potential applications, both functional (such as flat panel display (Q. H. Wang, M. Yan, and R. P. H. Chang, “Flat panel display prototype using gated carbon nanotube field emitters”, Applied Physics Letters, 78(9) pp. 1294-1296 (2001)) and structural applications (such as being used as inter-layers in composites to enhance laminate stiffness and damping (N. A. Koratkar, B. Wei, and P. M. Ajayan, “Multifunctional Structural Reinforcement Featuring Carbon Nanotube Films”, Composites Science and Technology, 63, 1525-1531 (2003)). Microwave plasma chemical vapor deposition (MPCVD) has been used to synthesize aligned nanotubes. These nanotubes are aligned either vertically to the substrate (C. Bower, W. Zhu, S. Jin, and O. Zhou, “Plasma-Induced Alignment of Carbon Nanotubes”, Applied Physics Letters, 77 (6), 830 (2000); C. O. Zhou, W. Zhu, D. J. Werder, and S. Jin, “Nucleation and Growth of Carbon Nanotubes by Microwave Plasma Chemical Vapor Deposition”, Applied Physics Letters, 77 (17), 2767 ( 2000); H. Cui, O. Zhou, and B. R. Stoner, “Deposition of Aligned Bamboo-Like Carbon Nanotubes via Microwave Plasma Enhanced Chemical Vapor Deposition”, Journal of Applied Physics, 88 (10), 6072 (2000); Y. C. Choi, Y. M. Shin, S. C. Lim, D. J. Bae, Y. H. Lee, B. S. Lee, and D. Chung, “Effect of Surface Morphology of Ni Thin Film on the Growth of Aligned Carbon Nanotubes by Microwave Plasma-Enhanced Chemical Vapor Deposition”, Journal of Applied Physics, 88 (8), 4898 (2000); Y. C. Choi, D. J. Bae, Y. H. Lee, B. S. Lee, G. Park, W. B. Choi, N. S. Lee, and J. M. Kim, “Growth of Carbon Nanotubes by Microwave Plasma-Enhanced Chemical Vapor Deposition at Low Temperature”, J. Vac. Sci. Technol. A, 18 (4), 1864 (2000); J. S. Gao, K. Umeda, K. Uchino, H. Nakashima, and K. Muraoka, “Plasma Breaking of Thin Films into Nano-Sized Catalysts for Carbon Nanotube Synthesis”, Materials Science & Engineering. A. Structural Materials: Properties, Microstructure and Processing. 352 (1), 308 (2003)), or parallel to the substrate (M. K. Singh, P. P. Singh, E. Titus, D. S. Misra, and F. Lenormand, “High Density of Multiwalled Carbon Nanotubes Observed on Nickel Electroplated Copper Substrates by Microwave Plasma Chemical Vapor Deposition”, Chemical Physics Letters, 354, 331 (2002)). The alignment was affected by catalyst grain sizes, growth temperature, and gas composition, among other factors. At un-optimized conditions, the nanotubes synthesized with MPCVD are often entangled (O. M. Küttel, O. Groening, C. Emmenegger, and L. Schlapbach, “Electron Field Emission From Phase Pure Nanotube Films Grown In A Methane/Hydrogen Plasma”, Applied Physics Letters, 73 (15), 2113 (1998); J. Yu, Q. Zhang, J. Ahn, S. F. Yoon, Rusli, Y. J. Li, B. Gan, and K. Chew, “Synthesis of Carbon Nanoparticles By Microwave Plasma Chemical Vapor Deposition and Their Field Emission Properties”, Journal of Materials Science Letters, 21, 543 (2002); S. H. Tsai, C. T. Shiu, S. H. Lai, L. H. Chan, W. J. Hsieh, H. C. Shih. “In Situ Growing and Etching of Carbon Nanotubes on Silicon under Microwave Plasma”, Journal of Materials Science Letters, 21, 1709 (2002); Y. M. Wong, W. P. Kang, J. L. Davidson, A. Wisitsora-At, K. L. Soh, T. Fisher, Q. Li And J. F. Xu, “Field Emitter Using Multiwalled Carbon Nanotubes Grown on the Silicon Tip Region by Microwave Plasma-Enhanced Chemical Vapor Deposition”, J. Vac. Sci. Technol. B, 21 (1), 391 (2003); Q. Zhang, S. F. Yoon, J. Ahn, B. Gan, Rusli, and M.-B. Yu, “Carbon Films with High Density Nanotubes Produced Using Microwave Plasma Assisted CVD”, Journal of Physics and Chemistry of Solids, 61, 1179-1183 (2000)). The nanotubes produced in a batch MPCVD process was usually several tens of micrometers long with aspect ratio in the range of 300 to 1500.

Objects

Therefore, it is an object of the present invention to provide a process for synthesizing long and well aligned carbon nanotubes. Also, it is an object to provide an integrated process for catalyst deposition and nanotube growth process within one apparatus economically. These and other objects will become increasingly apparent by reference to the following description and the drawings.

### SUMMARY OF THE INVENTION

The present invention relates to a process for the growth of a lawn of carbon nanotubes which comprises: (a) providing a metal catalyst on a stage in a closed microwave reactor adjacent to a substrate upon which the nanotubes are to be grown; (b) generating a first plasma in a reducing atmosphere comprising hydrogen in a reactor at a first elevated temperature which heats, vaporizes and deposits the metal catalyst onto the substrate; and (c) growing the carbon nanotubes in a second plasma of the reducing atmosphere and a carbon containing gas on the metal catalyst deposited on the substrate at a second temperature less than the first temperature to produce the lawn of carbon nanotubes on the substrate.

Preferably the substrate in step (a) is graphite and the catalyst is Ni, and in step (b) the plasma is generated in hydrogen alone as the reducing atmosphere. Most preferably in step (c), the carbon containing gas is introduced into the reactor with the hydrogen from step (b) to generate the carbon nanotubes. Preferably wherein the carbon containing gas is methane. Most preferably the metal catalyst in step (a) is Ni which is heated to between 700-740° C. as the first temperature in step (b). More preferably a power for generating the microwaves is 1.7 kW for step (b) and 2.2 kW for step (c). Preferably the nanotubes are grown in step (c) at about 650-700° C. Most preferably the reactor is flushed with argon to remove other gases, then pumped down to about 5 mtorr, hydrogen is introduced into the reactor as the reducing atmosphere, then a plasma is generated in the hydrogen in the reactor to heat the catalyst to about 700 to 740° C. to vaporize and deposit Ni as the catalyst onto the substrate which is graphite and then the nanotubes are grown in the plasma with hydrogen and methane at 650 to 700° C. to produce the lawn of carbon nanotubes on the substrate.

Preferably the metal catalyst is in a center portion of the stage in step (a) so that the lawn of nanotubes grows around the catalyst in step (c). Most preferably the substrate is silicon. Further, the present invention relates to a lawn of vertically aligned densely packed, individual carbon nanotubes coated on a catalyst for the growth of the nanotubes.

### BRIEF DESCRIPTION OF THE DRAWINGS

FIG. 1 is a cross-section of a prior art microwave plasma reactor used in this invention.

FIGS. 2A and 2B show nanotubes grown on graphite plate in Example 1 (a) before growth, and (b) after growth.

FIG. 3 is an SEM image (tilted 45°) of nanotubes grown on graphite in Example 1. Nanotube length is 200˜250 um. Scale bar is 100 um.

FIGS. 4A and 4B show a substrate setup in Example 2. FIG. 4A is a top view and FIG. 4B is a cross-section side view.

FIGS. 5A and 5B are SEM images (45° tilted) of nanotubes grown in example 2 on graphite and silicon. Nanotube length is 130 um.

FIG. 6 is a typical TEM image of the nanotubes grown with the method of the present invention. The diameter is 40˜70 nm. The scale bar is 200 nm.

FIG. 7 is a schematic view showing a possible carbon nanotube growth mechanism.

FIG. 8 shows the Si wafer on the graphite substrate.

### DESCRIPTION OF PREFERRED EMBODIMENTS

In the present invention, the synthesis of very long (length up to 250 micrometers and aspect ratio up to 4500) and well-aligned nanotubes with MPCVD method is described. Carbon nanotubes have many potential applications in nanotechnology, because of their superior stiffness, strength, toughness, thermal conductivity, and unique electrical properties. Microwave plasma chemical vapor deposition (MPCVD) is used to synthesize long and well-aligned carbon nanotubes at a high growth rate. Existing (“old”) MPCVD processes use two separate apparatus for catalyst deposition and nanotube growth. The present invention uses an integrated catalyst deposition and nanotube growth process within one chamber.

In this invention, nickel preferably was used to catalyze the nanotube growth on graphite or silicon substrates. However, the nickel was not deposited onto the substrates directly. Instead, nickel migrated from a small piece of catalyst supplier onto the substrates during microwave plasma pretreatment. Two sets of experiments were carried out. Experimental conditions are summarized in Table 1. The substrate was heated with plasma only. The temperature was measured with a pyrometer as shown in FIG. 1.

After synthesis, a piece of nanotube film was collected from the substrates and was examined with Scanning Electron Microscope (SEM, Camscan 44 Field Emission) to obtain information on the alignment and length of the nanotubes. Transmission Electron Microscope (TEM) was used to measure the diameter and to study the morphology of the nanotubes. The TEM samples were prepared by dispersing nanotubes in acetone with ultrasonication for several minutes, and then casting a drop of the solution on a copper grid coated with formvar and carbon.

In the “old” MPCVD processes, a thin catalyst layer is first deposited on substrates by sputtering, pulsed laser, or other methods. Then the substrates covered with catalyst are transferred into plasma chamber to grow nanotubes. Both steps require pumping to a high vacuum and preheating. With the method of the present invention, the catalyst is deposited onto the substrates while the substrates are preheated to the nanotube synthesis temperature and held at that temperature for a short while with microwave plasma. Then carbon source gas is introduced to grow the nanotubes.

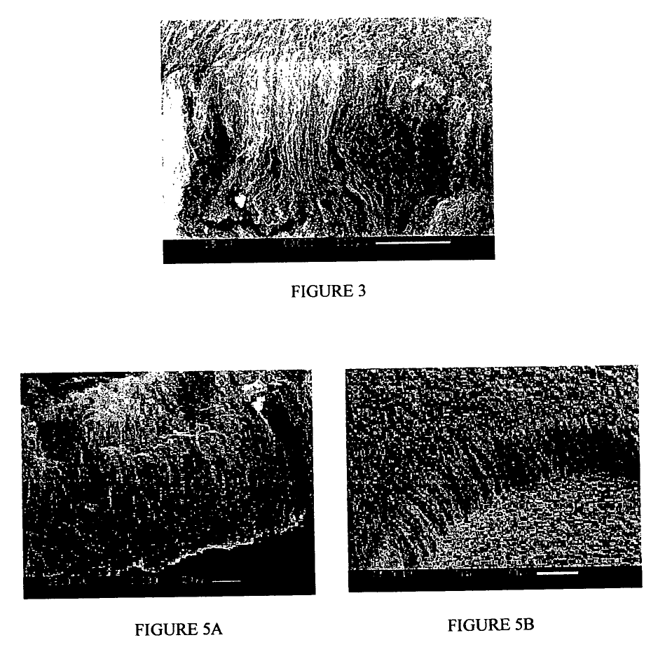

The advantages of the process of the present invention over existing processes include:
(1) Equipment savings: Both catalyst deposition and nanotube growth take place in the same microwave plasma chamber, instead of two separate facilities required by other existing processes.
(2) Time and energy savings: the system only needs to be pumped to high vacuum and preheated once.
(3) Good properties of the product: The nanotubes synthesized with the present process are long and well-aligned, as shown in FIG. 3.

The nanotubes synthesized with this process have many potential applications, including cold cathode flat panel display, composites reinforcement and damping treatment. Currently the applications of nanotubes are limited by their very high cost. The present process reduces the manufacturing cost if used in large scale fabrication, and provides controlled unique properties of the nanotubes.

The catalyst deposition was based on a catalyst migration phenomenon in a microwave plasma. This phenomenon was discovered by the present inventors. The preferred experimental steps are listed as follows:
1) Put a small piece of catalyst supplier (such as nickel target) on a graphite silicon or other plate and place the plate into the microwave plasma reactor. The microwave plasma reactor is described in the Asmussen et al patents U.S. Pat. Nos. 4,507,588; 4,585,688; 4,630,566; 4,727,293 and 5,081,398 which are incorporated here by reference. The cross-section of the reactor is shown in FIG. 1.
2) Pump the system to a vacuum of 5 mtorr. Purge with 365 sccm (Standard Cubic Centimeters per Minute) Argon for several minutes. After turning off Argon, pump the system to 5 mtorr again.
3) Start 80 sccm hydrogen flow. Ignite hydrogen plasma at 5 torr pressure. Heat the nickel to 700˜740° C. (corresponding to 35˜40 torr) in 15˜18 minutes, with a microwave power of 1.7 kW.
4) Increase microwave power to 2.2 kW and continue the pretreatment for around one minute.
5) Add 20sccm methane into the plasma chamber to start nanotube growth. The temperature of the nanotube growth area is around 650˜700° C., lower than that of the catalyst supplier. The growth time was 20 minutes.

This process can obtain similar results with other transition metals such as iron and cobalt, which have been used for catalyzing nanotube growth in CVD processes. The experimental conditions can be slightly different.

Two sets of experiments were carried out. Experimental conditions are summarized in Table 1 as Examples 1 (prior art) and 2 (the present invention).

TABLE 1
Experimental conditions for nanotube synthesis

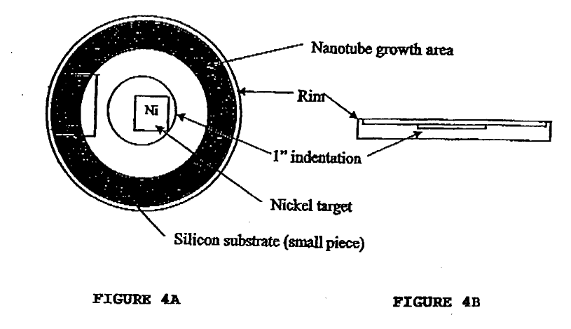

Example

| | 1 | 2 |
|---|---|---|
| Catalyst supplier | Silicon | Nickel target |
| | sputter | |
| | deposited with | |
| | a 30 nm nickel | |
| | layer | |
| Substrate for | Graphite (3″ | Graphite (3″ |
| nanotube growth | diameter, 2″ | diameter, 1″ |
| | indentation, | indentation), and |
| | see FIG. 3) | a small piece of |
| | | silicon (placed at |
| | | the edge of |
| | | graphite plate), |
| | | see FIG. 5 |
| Hydrogen flow rate | 80 | 80 |
| (sccm) | | |
| Methane flow rate | 20 | 20 |
| (sccm) | | |
| Pressure (torr) | 35-37 | 37-40 |
| Microwave power | 1.7 at first, | 1.7 at first, |
| during pretreatment | increase to | increase to 2.2 in |
| (kW) | 2.2 in the | the last min |
| | last min | |
| Microwave power | 2.2 | 2.2 |
| during nanotube | | |
| growth (kW) | | |
| Temperature of | 700-720 | 710-740 |
| catalyst supplier | | |
| (° C.) | | |
| Temperature of | 680-700 | 650-690 |
| nanotube growth area | | |
| (° C.) | | |
| Growth time (min) | 20 | 20 |

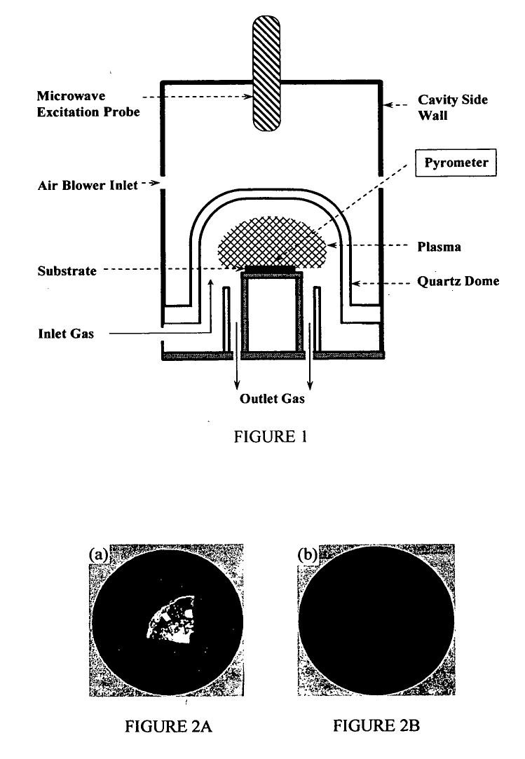

The graphite substrate used in Example 1 is shown in FIGS. 2A and 2B. The substrate had a diameter of 3″. The indentation area had a diameter of 2″. The darker and lighter regions are nanotubes and original graphite surface, respectively. (Note: the contrast of the photo was increased from its original state to reveal the different regions.) The square shaped region with light color in the indentation area was the position of the catalyst supplier. The nanotube growth covered almost all the 2″ indentation area and covered part of the outer circle.

After synthesis, the nanotube film was collected from the graphite plate with a razor blade. The alignment and length of the nanotubes were examined with a Scanning Electron Microscope (SEM, Camscan 44 Field Emission). A small piece of nanotube film was mounted on carbon tape and then on an SEM sample stage. The SEM image of the nanotubes grown in Example 1 is shown in FIG. 3. The nanotubes are 200-250 micrometer long and are aligned vertically to the substrate surface.

In Example 2, a graphite plate with 3″ diameter and 1″ indentation was used so that the nickel target could be closer to the center. In addition, a piece of silicon substrate (with unpolished side up) was put at the edge of the graphite plate. The sketch of the substrate setup is shown in FIG. 4. Nanotubes grew on the silicon as well as on the outer circle of the graphite plate. After growth, the silicon was directly mounted onto SEM sample stage for imaging. FIGS. 5A and 5B show the SEM images of the nanotubes synthesized in Example 2. The nanotubes are also vertically aligned, but have a length around 130um, shorter than that obtained in Example 1. This might result from lower growth temperature.

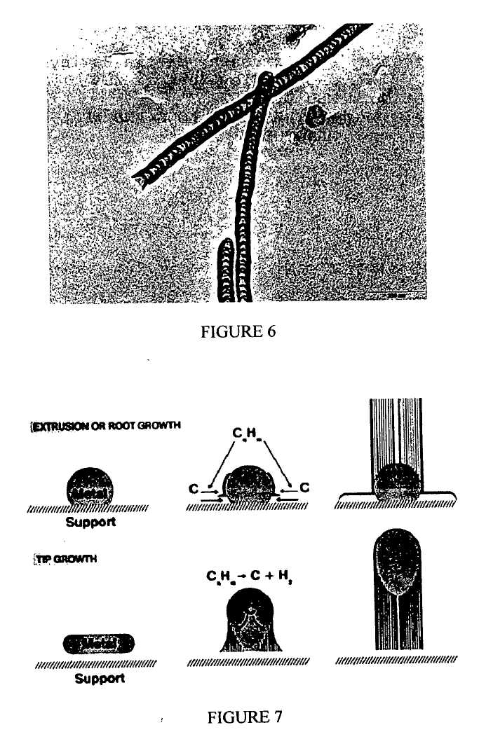

Transmission Electron Microscope (TEM) was used to measure the diameter and to study the morphology of the nanotubes. The TEM samples were prepared by dispersing the nanotubes in acetone with ultrasonication for several minutes, and then casting a drop of the solution on a copper grid coated with formvar and carbon. FIG. 6 shows the TEM image of the nanotubes. The diameters of the nanotubes are in the range of 40 to 70 nm. They are not completely hollow and seem to be separated into many nano-compartments by curved platelets. The platelets were much thinner than the nanotube walls. Similar structures were observed by other researchers (H. Cui, O. Zhou, and B. R. Stoner, “Deposition of Aligned Bamboo-Like Carbon Nanotubes via Microwave Plasma Enhanced Chemical Vapor Deposition”, Journal of Applied Physics, 88 (10), 6072 (2000); Y. C. Choi, Y. M. Shin, S. C. Lim, D. J. Bae, Y. H. Lee, B. S. Lee, and D. Chung, “Effect of Surface Morphology of Ni Thin Film on the Growth of Aligned Carbon Nanotubes by Microwave Plasma-Enhanced Chemical Vapor Deposition”, Journal of Applied Physics, 88 (8), 4898 (2000); Y. C. Choi, D. J. Bae, Y. H. Lee, B. S. Lee, G. Park, W. B. Choi, N. S. Lee, and J. M. Kim, “Growth of Carbon Nanotubes by Microwave Plasma-Enhanced Chemical Vapor Deposition at Low Temperature”, J. Vac. Sci. Technol. A, 18 (4), 1864 (2000); J. S. Gao, K. Umeda, K. Uchino, H. Nakashima, and K. Muraoka, “Plasma Breaking of Thin Films into Nano-Sized Catalysts for Carbon Nanotube Synthesis”, Materials Science & Engineering. A. Structural Materials: Properties, Microstructure and Processing. 352 (1), 308 (2003); M. K. Singh, P.P. Singh, E. Titus, D. S. Misra, and F. Lenormand, “High Density of Multiwalled Carbon Nanotubes Observed on Nickel Electroplated Copper Substrates by Microwave Plasma Chemical Vapor Deposition”, Chemical Physics Letters, 354, 331 (2002); O. M. Küttel, O. Groening, C. Emmenegger, and L. Schlapbach, “Electron Field Emission From Phase Pure Nanotube Films Grown In A Methane/Hydrogen Plasma”, Applied Physics Letters, 73 (15), 2113 (1998); J. Yu, Q. Zhang, J. Ahn, S. F. Yoon, Rusli, Y. J. Li, B. Gan, and K. Chew, “Synthesis of Carbon Nanoparticles By Microwave Plasma Chemical Vapor Deposition and Their Field Emission Properties”, Journal of Materials Science Letters, 21, 543 (2002); S. H. Tsai, C. T. Shiu, S. H. Lai, L. H. Chan, W. J. Hsieh, H. C. Shih. “In Situ Growing and Etching of Carbon Nanotubes on Silicon under Microwave Plasma”, Journal of Materials Science Letters, 21, 1709 (2002); Y. M. Wong, W. P. Kang, J. L. Davidson, A. Wisitsora-At, K. L. Soh, T. Fisher, Q. Li And J. F. Xu, “Field Emitter Using Multiwalled Carbon Nanotubes Grown on the Silicon Tip Region by Microwave Plasma-Enhanced Chemical Vapor Deposition”, J. Vac. Sci. Technol. B, 21 (1), 391 (2003); E. G. Wang, Z. G. Guo, J. Ma, M. M. Zhou, Y. K. Pu, S. Liu, G. Y. Zhang, and D. Y. Zhong, “Optical emission spectroscopy study of the influence of nitrogen on carbon nanotube growth”, Carbon, 41, 1827-1831 (2003)).

The morphologies might be related with the nanotube growth mechanism. The nanotubes can grow from its root, and/or tip, depending on the positions of the catalyst particles. In this invention, nickel was detected at the top of nanotubes with Energy Dispersive x-ray Spectrometer (EDS), indicating a tip growth route. The most widely accepted growth model of carbon nanotubes was adapted from the catalytic synthesis of carbon fibers, shown in FIG. 7B. In this model, the hydrocarbon first decomposes into carbon and hydrogen at the front (exposed) face of the catalyst particle. Then the carbon dissolves in the catalyst, diffuses through the particle, and precipitates at the trailing face to form the nanotube (P. J. F. Harris, Carbon Nanotubes and Related Structures, Publisher: Cambridge University Press, November 1999, pp. 30-33; M. J. M. Daenen, R. de Fouw, B. Hamers, P. G. A. Janssen, K. Schouteden, and M. A. J. Veld, “a review on current carbon nanotube technologies”, http://www.pa.msu.edu/cmp/csc/nanotube.html). If no carbon is deposited at the apex of the trailing face, then hollow nanotubes form. The formation of the curved thin platelet inside the nanotubes in this study can result from rapid carbon deposition at the entire trailing surface. FIG. 7A shows an alternate theory.

Currently, the catalyst only migrates to the outer circle of the substrates when a small piece of nickel target is used as catalyst supplier. Factors that affect the catalyst migration include temperature, hydrogen flow rate, and microwave power. These factors allow the design of an optimized process for nanotubes synthesis over a large area.

Thus, a MPVCD method was used to synthesize carbon nanotubes on graphite and silicon substrates. The nanotubes growth was catalyzed by nickel, which migrated onto the substrates during microwave plasma pretreatment. SEM imaging showed that the nanotubes grown with this method were aligned vertically to the substrate surface and were up to 250 micrometers long within 20 minute of growth at temperatures between 650° C. and 700° C. TEM results showed that the nanotubes had diameters in the range of 40 to 70 nanometers. The nanotubes were not completely hollow and were separated into many nano-compartments by curved platelets. Similar structures were observed by other research groups. Possible mechanisms for nanotube growth and vertical alignment in the MPCVD process were described. The carbon nanotubes produced with this method are aligned vertically to the substrate surface. The nanotubes produced with the processes in the existing prior art are entangled.

The process of the present invention enables growth on a variety of substrates as seen from Examples 3 and 4.

### EXAMPLES 3 AND 4

Experimental System

The MPCVD system used is shown in FIG. 1. The microwave power was controlled by hand while the gas flows were controlled by the computer. The growth temperature of carbon nanotubes (CNTs) was measured by a pyrometer via the screen side window.

Experimental Materials

The silicon substrate used to grow CNTs was a boron-doped-p-type Si <100> substrate with an electric resistivity of 10 Ωcm from Silicon Sense Inc. (Nashua, N.H.). The diameter of the Si wafer was 2 in. and the dopant was Boron. Its orientation was <100> and resistivity was 1-10 ohm-cm, with a thickness of 254-304 μm.

Unpurified single wall nanotubes (SWNTs), which were coated on the Si wafers before CNT growth, were from the labs of Professor James M. Tour at Center of Nanoscale Science and Technology at Rice University. The unpurified SWNTs contain amorphous carbon, Fe, and with the SWNTs. The iron content of the SWNTs is on the order of 7% by weight.

The catalyst used for the nanotube synthesis was nickel. Two samples were made for the synthesis—i) a thin film of Ni with a thickness of 30 nm is deposited using dc magnetron sputtering on the Si wafer (prior art) or ii) a 3 inch pure Ni (99.999%) target from K. J. Lesker Company (Clairton, Pa.) was placed on the Si wafer. For the second case, the deposition process took place in the microwave reactor, under an Ar pressure of 4.0 mTorr at a substrate temperature of 400° C. The working distance from the Ni target to the Si wafer was 2.5 inch while deposition power was 200W.

Experimental Procedure

For the silicon substrate coating (Example 3), 1 mg unpurified SWNT was mixed with 40 mL HPLC grade acetone in a beaker. The mixture was stirred two hours under ultrasonic agitation. The beaker was covered with aluminum foil to prevent evaporation loss and spill. Then, the Si wafer was coated with 0.15-0.2 ml SWNT mixture. The Si wafer was air dried for up to 24 hours.

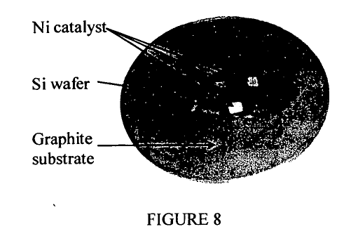

Three small pieces (around 5×5 mm2) of Ni catalyst supplier were placed on one quarter of one SWNT-coated Si wafer. The Si wafer was placed on a graphite plate and the plate was put into the microwave plasma reactor of the MPCVD system or shown in FIG. 8.

The system was vacuumed pumped to a base pressure of less than 5 mTorr and purged with Argon at 365 sccm (Standard Cubic Centimeters per Minute) for 20 minutes. After turning off Ar gas, the system was pumped to around 0 torr for 5 minutes.

Hydrogen was pumped into the reactor at a set flow rate, and the microwave plasma was ignited at 2kW when the pressure of the reactor reached 5 Torr. The Ni catalysts were heated by H₂ plasma to about 700° C. with a microwave power of 1.7 kW (total power 2 kW). Then, methane with a set flow rate was introduced into the plasma chamber to start CNT growth. Microwave power was increased to 2.2 kW with a total power of 3 kW to keep the CNT growth temperature is about 750-800° C. If the temperature was higher than 800° C., the microwave power needs to be lowered. The growth time was 20 minutes.

After synthesis of CNTs, a SEM (JEOL 6300F) was used to examine the morphology of the CNTs. A small piece of CNTs on the Si wafer was cut and mounted on a SEM holder (45° tilted). The sample was coated gold before SEM study. A TEM (JEM-2200FS) was used to investigate the microstructure of CNTs. The results were similar to Examples 1 and 2.

It is intended that the foregoing description be only illustrative of the present invention and that the present invention be limited only by the hereinafter appended claims.

We claim:

1. A process for the growth of a lawn of carbon nanotubes which comprises:
(a) providing a metal catalyst on a stage in a closed microwave reactor adjacent to a substrate upon which the nanotubes are to be grown;
(b) generating a first plasma in a reducing atmosphere comprising hydrogen in a reactor at a first elevated temperature which heats, vaporizes and deposits the metal catalyst onto the substrate; and
(c) growing the carbon nanotubes in a second plasma of the reducing atmosphere and a carbon containing gas on the metal catalyst deposited on the substrate at a second temperature less than the first temperature to produce the lawn of carbon nanotubes on the substrate.

2. The process of claim 1 wherein the substrate in step (a) is graphite and the catalyst is Ni, and wherein in step (b) the plasma is generated in hydrogen alone as the reducing atmosphere.

3. The method of claim 2 wherein in step (c) the carbon containing gas is introduced into the reactor with the hydrogen from step (b) to generate the carbon nanotubes.

4. The method of claim 3 wherein the carbon containing gas is methane.

5. The method of claim 1 wherein the metal catalyst in step (a) is Ni which is heated to between 700-740° C. as the first temperature in step (b).

6. The method of claim 1 wherein a power for generating the microwaves is 1.7 kW for step (b) and 2.2 kW for step (c).

7. The method of claim 1 wherein the nanotubes are grown in step (c) at about 650-700° C.

8. The process of claim 1 wherein the reactor is flushed with argon to remove other gases, then pumped down to about 5 mtorr, hydrogen is introduced into the reactor as the reducing atmosphere, then a plasma is generated in the hydrogen in the reactor to heat the catalyst to about 700 to 740° C. to vaporize and deposit Ni as the catalyst onto the substrate which is graphite and then the nanotubes are grown in the plasma with hydrogen and methane at 650 to 700° C. to produce the lawn of carbon nanotubes on the substrate.

9. The process of claim 1 wherein the metal catalyst is in a center portion of the stage in step (a) so that the lawn of nanotubes grows around the catalyst in step (c).

10. The process of claim 1 wherein the substrate is silicon.

11. A lawn of vertically aligned densely packed, individual carbon nanotubes coated on a catalyst for the growth of the nanotubes.
